(19) United States
(12) Patent Application Publication
(10) Pub. No.: US 2026/0032494 A1
(43) Pub. Date: Jan. 29, 2026

(54) Fast Channel State Information Reporting Configuration Updates for Neighbor Cells

(71) Applicant: Apple Inc., Cupertino, CA (US)

(72) Inventors: Hong He, San Jose, CA (US); Haitong Sun, Saratoga, CA (US); Dawei Zhang, Saratoga, CA (US); Wei Zeng, Saratoga, CA (US); Chunxuan Ye, San Diego, CA (US); Jie Cui, San Jose, CA (US)

(21) Appl. No.: 19/150,016

(22) PCT Filed: Jan. 24, 2024
(86) PCT No.: PCT/US2024/012737

§ 371 Date: Jul. 22, 2025

Related U.S. Application Data
(60) Provisional application No. 63/485,324, filed on Feb. 16, 2023.

(51) Int. Cl. H04W 24/10; H04B 7/06; H04W 72/231

(52) U.S. Cl. CPC H04W 24/10; H04B 7/0626; H04W 72/231

(57) ABSTRACT

This disclosure relates to techniques for configuring and performing channel state information measurement reporting for neighbor cells in a wireless communication system. A wireless device and a cellular base station may establish a wireless link. The wireless device may receive configuration information for channel state information reporting for one or more non-serving cells from the cellular base station via media access control signaling. The wireless device may receive an indication triggering aperiodic channel state information reporting for at least one non-serving cell from the cellular base station. The wireless device may perform the aperiodic channel state information reporting for the non-serving cell using the configuration information received via media access control signaling.

### FIELD

The present application relates to wireless communications, and more particularly to systems, apparatuses, and methods for configuring and performing channel state information measurement reporting for neighbor cells in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for configuring and performing channel state information measurement reporting for neighbor cells in a wireless communication system.

According to the techniques described herein, it may be possible to reduce the latency and signaling burden for configuring channel state information reporting for neighbor cells by introducing media access control based signaling for updating various possible aspects of the aperiodic channel state information reporting configuration for a wireless device. Such signaling may be able to support updating the channel state information reporting configurations associated with a downlink control information channel state information trigger state codepoint, in some embodiments. Updating the association between a channel state information reporting configuration and one or more channel state information resource configurations may also or alternatively be possible. In some instances, it may further be possible to update the reference signal resources associated with a channel state information resource set.

Techniques are also described herein for supporting configuring a transmission control indicator state for a neighbor cell. Such configuration may be performed using any of a number of possible variations on providing a transmission control indicator state list that includes cell identification information for identifying which transmission control indicator state entries are associated with which (serving or non-serving) cell, in some embodiments. Such techniques may facilitate the use of channel state information reference signals for performing neighbor cell layer one measurements, which may in turn have the potential to improve the accuracy and efficiency of low latency layer one layer two triggered mobility operations, at least in some instances.

Still further, techniques are described herein for maintaining offset information for channel state information measurements performed for neighbor cells. According to such techniques, it may be possible for a wireless device to temporarily store the timing offset and frequency offset information for certain non-serving cells that may be considered likely candidates for cell-switching or transmission control indicator activation, which may reduce or avoid downlink re-synchronization time and thus potentially reduce the overall latency of such mobility operations, at least in some instances.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for fast updating aperiodic channel state information configuration for neighbor cells in a wireless communication system, according to some embodiments;

FIG. 6 is a flowchart diagram illustrating aspects of an exemplary possible method for configuring a transmission control indicator for a neighbor cell, according to some embodiments;

FIG. 7 is a flowchart diagram illustrating aspects of an exemplary possible method for storing offset information for a neighbor cell, according to some embodiments;

FIG. 8 illustrates an example of a possible media access control (MAC) control element (CE) format that can be used for fast channel state information trigger state updating for neighbor cells, according to some embodiments;

FIG. 9 illustrates aspects of an example scenario in which fast aperiodic channel state information configuration updating could be used, according to some embodiments;

FIG. 10 illustrates an example of a possible MAC CE format that can be used for fast channel state information reporting configuration updating for neighbor cells, according to some embodiments;

FIG. 11 illustrates an example of a possible MAC CE format that can be used for fast channel state information resource configuration updating for neighbor cells, according to some embodiments;

FIGS. 12-13 illustrate examples of possible ASN.1 code that could be used for configuring transmission control indicator states for non-serving cells, according to some embodiments; and

FIGS. 14-15 illustrate aspects of an example neighbor cell measurement scenario in which selected offset information can be temporarily stored, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point
RRC: Radio Resource Control
MAC: Media Access Control
DCI: Downlink Control Information
CSI: Channel State Information

### Terms

The following is a glossary of terms that may appear in the present disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.
User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.
Wireless Device—any of various types of computer systems or devices that perform wireless communications. A wireless device can be portable (or mobile) or may be stationary or fixed at a certain location. A UE is an example of a wireless device.
Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.
Base Station (BS)—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well as any of various combinations of the above.
Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

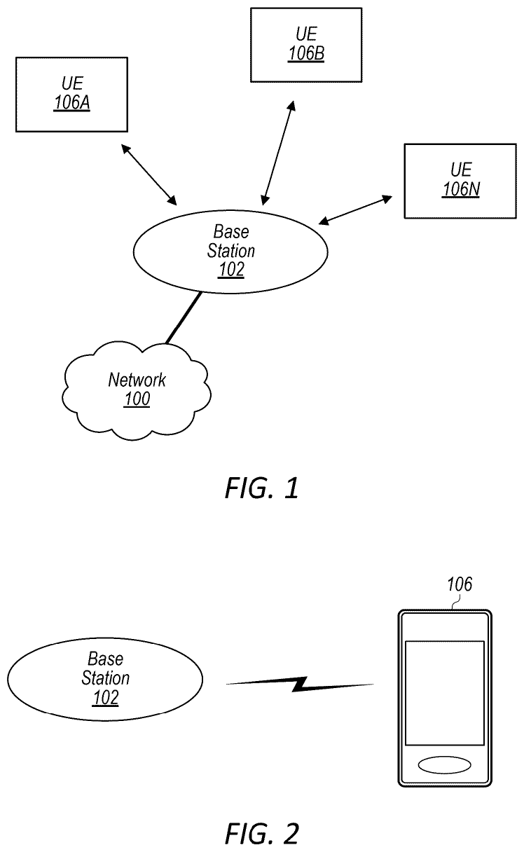

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP NR contexts, base station (gNB) functionality can be split between a centralized unit (CU) and a distributed unit (DU). The illustrated base station 102 may support the functionality of either or both of a CU or a DU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000(e.g., 1xRTT, 1xEV-DO, HRPD, cHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for channel state information measurement reporting for neighbor cells in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing clement) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1xRTT (or LTE or NR, or LTE or GSM), and separate radios for communicating using each of Wi-Fi and BLUETOOTH™. Other configurations are also possible.

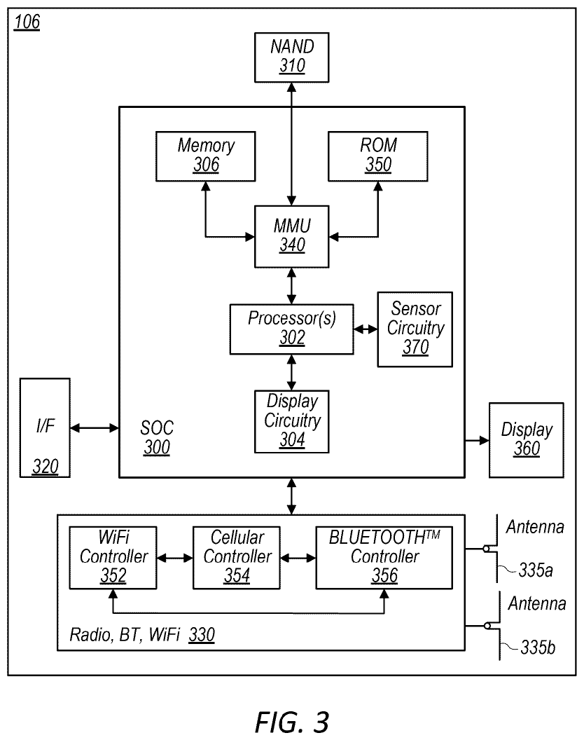

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for channel state information measurement reporting for neighbor cells in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for channel state information measurement reporting for neighbor cells in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

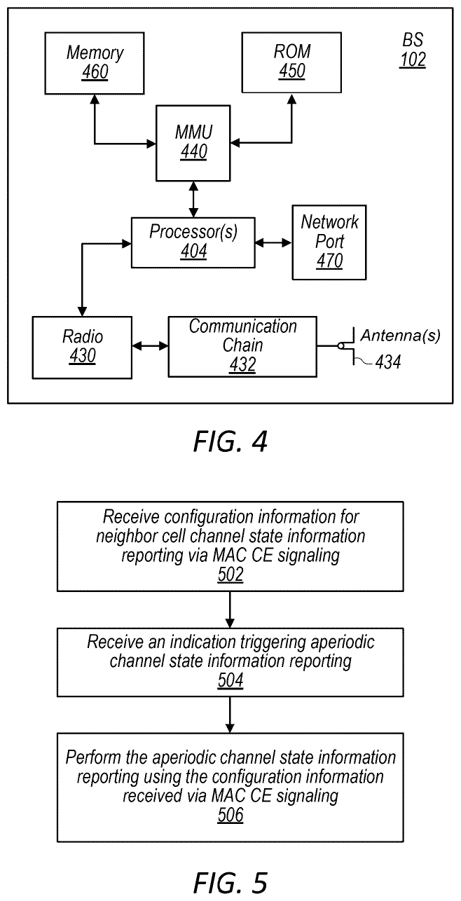

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Reference Signals

A wireless device, such as a user equipment, may be configured to perform a variety of tasks that include the use of reference signals (RS) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource set for measuring the quality of the downlink channel and reporting information related to this quality measurement to the base station), among various possibilities. For example, in the case of CSI-RS for CSI acquisition, the UE may periodically perform channel measurements and send channel state information (CSI) to a base station. The base station can then receive and use this channel state information to determine an adjustment of various parameters during communication with the wireless device. For example, a base station may use the received channel state information to adjust the coding of its downlink transmissions to improve downlink channel quality. It may also be possible for a wireless device to perform channel state information reporting for reference signals transmitted by neighbor cells, which may for example be configured by the serving base station to facilitate handover decision-making.

In many cellular communication systems, the base station may transmit some or all such reference signals (or pilot signals), such as SSB and/or CSI-RS, on a periodic basis. In some instances, aperiodic reference signals (e.g., for aperiodic CSI reporting) may also or alternatively be configured and provided.

### FIGS. 5-7—Channel State Information Measurement Reporting for Neighbor Cells

To support low latency and high reliability mobile services, the importance of being able to quickly shift cells as needed to maintain Quality of Service may be heightened. Techniques for achieving such cell shifting through lower layer signaling, such as 3GPP Release 18 layer 1 (L1) layer 2 (L2) triggered mobility (LTM) techniques, are under development, and may be expected to reduce latency and improve reliability for at least some wireless devices, according to some embodiments.

Wireless device mobility, whether performed at lower layers such as may be the case for a LTM procedure or at higher layers such as may be the case for a more conventional handover managed at the radio resource control (RRC) layer, typically relies at least in part upon timely and accurate neighbor (non-serving) cell measurements. For example, in order to determine which cell (and potentially which beam for that cell) to target to best provide service to a wireless device, it may be important to know which nearby available cells have good signal strength and/or signal quality. Accordingly, similar to the potential latency reduction and reliability increase that may be obtained by supporting more aspects of mobility procedures being performed at lower layers, there may also be benefits to increasing support for providing channel state information reporting configuration information at lower layers. For example, such techniques may allow for a wireless device to be reconfigured to perform channel condition measurements for the most relevant non-serving cells and beams more quickly, which can in turn further reduce latency and reliability of mobility operations for the wireless device, at least in some instances.

Thus, it may be beneficial to specify techniques for supporting channel state information reporting for neighbor cells with low latency and signaling overhead, as well as other techniques for increasing the accuracy, reducing the latency and signaling overhead, and/or increasing the reliability of wireless device mobility operations. To illustrate various such possible techniques, FIGS. 5-7 are flowchart diagrams illustrating various methods for configuring and performing channel state information measurement reporting for neighbor cells in a wireless communication system, at least according to some embodiments. Note that the methods of FIGS. 5-7 may be used individually/independently or in any of a variety of possible combinations, according to various embodiments.

Aspects of the methods of FIGS. 5-7 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the methods of FIGS. 5-7 are described in a manner relating to the use of communication techniques and/or features associated with 3GPP and/or NR specification documents, such description is not intended to be limiting to the disclosure, and aspects of the methods of FIGS. 5-7 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the methods of FIGS. 5-7 may operate as follows.

The wireless device may establish a wireless link with a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

In some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time.

At least in some instances, establishing the wireless link(s) may include the wireless device providing capability information for the wireless device. Such capability information may include information relating to any of a variety of types of wireless device capabilities.

FIG. 5 may relate more particularly to a method for providing channel state information configuration information for non-serving cells using media access control signaling, according to some embodiments. As shown, in 502, the wireless device may receive configuration information for neighbor cell channel state information (CSI) reporting from the cellular base station via MAC CE signaling. The MAC CE signaling may be used to configure any of a variety of possible aspects of CSI reporting for non-serving cells of the wireless device, according to various embodiments.

In some embodiments, the MAC CE signaling may configure one or more CSI reporting configurations to be associated with a downlink control information (DCI) CSI trigger state codepoint. For example, one or more CSI reporting configurations associated with non-serving cells may be configured to be associated with the DCI CSI trigger state codepoint, such that if the CSI trigger state codepoint is indicated to the wireless device by the serving cellular base station via DCI signaling, the wireless device is triggered to perform CSI measurement and reporting according to the CSI reporting configurations associated with the CSI trigger state codepoint.

In some embodiments, the CSI reporting configurations associated with the DCI CSI trigger state codepoint by the MAC CE signaling may be identified using CSI reporting configuration IDs provided for the CSI reporting configurations by RRC signaling. Note that if such an approach is used, it may be possible that the MAC CE signaling can be used to configure either of serving cell or non-serving cell CSI reporting configurations to be associated with the DCI CSI trigger state codepoint, at least according to some embodiments.

In another approach, it may be possible that the CSI reporting configurations that can be associated with the DCI CSI trigger state codepoint by the MAC CE signaling are limited to non-serving cell CSI reporting configurations. As one such possibility, the CSI reporting configurations associated with the DCI CSI trigger state codepoint by the MAC CE signaling may be identified using non-serving cell group index based identifiers, which may be determined/assigned by the wireless device and the serving cellular base station only for those CSI reporting configurations associated with non-serving cells. For example, the wireless device may determine which CSI reporting configuration IDs are associated with non-serving cells among all CSI reporting configuration IDs (e.g., that may have been indicated to the wireless device via RRC signaling, and that may include both CSI reporting configurations IDs associated with the serving cell and CSI reporting configurations IDs associated with non-serving-cells). Those CSI reporting configuration IDs that are associated with non-serving cells may be indexed (e.g., based on their CSI reporting configuration IDs, as one possibility) to determine the non-serving cell group indices for the CSI reporting configuration IDs that are associated with non-serving cells.

In some embodiments, the MAC CE signaling may configure one or more CSI resource configurations to be associated with a CSI reporting configuration. For example, one or more CSI resource configurations associated with non-serving cells may be configured to be associated with the CSI reporting configuration, such that if the wireless device receives an indication to perform CSI reporting according to the CSI reporting configuration (such as if a DCI CSI trigger state codepoint associated with the CSI reporting configuration is received by the wireless device), the CSI measurement and reporting may be performed using the CSI resource configuration(s) associated with non-serving cells.

In one possible approach, the CSI reporting configuration may be identified in the MAC CE signaling using its CSI reporting configuration ID (e.g., which may have been provided for the CSI reporting configuration by RRC signaling). Similarly, in some embodiments, the CSI resource configuration(s) associated with the CSI reporting configuration may be identified in the MAC CE signaling using CSI resource configuration ID(s) (e.g., which may have been provided for the CSI resource configuration(s) by RRC signaling). Note that if such an approach is used, it may be possible that the MAC CE signaling can be used to configure either of serving cell or non-serving cell CSI resource configurations to be associated with the CSI reporting configuration, at least according to some embodiments.

In another approach, it may be possible that the CSI reporting configurations and/or CSI resource configurations that can be associated with each other by the MAC CE signaling are limited to non-serving cell CSI resource configurations and/or non-serving cell CSI reporting configurations. As one such possibility, the CSI reporting configuration may be identified in the MAC CE signaling using a non-serving cell group index based identifier, which may be determined/assigned by the wireless device and the serving cellular base station only for those CSI reporting configurations associated with non-serving cells. As another such possibility, the CSI resource configuration(s) may be identified in the MAC CE signaling using non-serving cell group index based identifiers, which may be determined/assigned by the wireless device and the serving cellular base station only for those CSI resource configurations associated with non-serving cells. In a similar manner as previously described herein, such non-serving cell group index based identifiers may be determined by assigning non-serving cell group indices to only those CSI reporting configurations or CSI resource configurations, respectively, within the group of non-serving cell CSI reporting configurations or non-serving cell CSI resource configurations, respectively. The indices may be assigned based on RRC assigned CSI reporting configuration IDs and RRC assigned CSI resource configuration IDs (e.g., indexed in ascending order of those identifiers), or may be indexed in any of various other ways, according to various embodiments.

In some embodiments, the MAC CE signaling may configure one or more reference signal (RS) resources to be associated with a CSI resource set. For example, one or more RS resources associated with non-serving cells may be configured to be associated with the CSI resource set, such that if the wireless device receives an indication to perform CSI reporting using the CSI resource set, the CSI measurement and reporting may be performed using the RS resource(s) associated with non-serving cells.

At least in some embodiments, it may be possible that such MAC CE signaling indicates a reference signal type for the RS resources to be associated with the CSI resource set, for example selected from CSI-RS or CSI-SSB. This may identify whether the CSI resource set is a CSI-RS resource set or a CSI-SSB resource set. The MAC CE signaling may further indicate a CSI resource set ID, which may refer to a CSI-RS resource set ID or a CSI-SSB resource set ID, e.g., depending on the indicated type of RS signaled by the MAC CE. Additionally, the MAC CE signaling may indicate one or more non-zero-power (NZP) CSI-RS resource IDs or SSB indices (e.g., again depending on the indicated type of RS) that are included in the CSI resource set.

For whichever aspect(s) of non-serving cell CSI reporting the MAC CE provides configuration information, it may be the case that the MAC CE signaling indicates a non-serving cell identifier and bandwidth part identifier associated with the configuration information for CSI reporting. This may provide an indication from the cellular base station to the wireless device of the non-serving cell to which the CSI reporting configuration information applies, at least according to some embodiments.

Additionally, in some embodiments, it may be possible that a single MAC CE could provide CSI reporting configuration information for multiple non-serving cells. For example, in a scenario in which the MAC CE signaling configures multiple CSI reporting configurations to be associated with a DCI CSI trigger state codepoint, it could be possible that those CSI reporting configurations span multiple non-serving cells. To handle such a scenario, at least in some embodiments, it may be possible that the MAC CE includes portions configuring one or more CSI reporting configurations associated with the DCI CSI trigger state codepoint for each of the applicable non-serving cells. Similarly, in a scenario in which the MAC CE signaling configures multiple CSI resource configurations to be associated with a CSI reporting configuration, it could be possible that those CSI resource configurations span multiple non-serving cells. To handle such a scenario, at least in some embodiments, it may be possible that the MAC CE includes portions configuring one or more CSI resource configurations associated with the CSI reporting configuration for each of the applicable non-serving cells.

In 504, the wireless device may receive an indication triggering aperiodic CSI reporting from the cellular base station. In some embodiments, this may include receiving a CSI trigger state codepoint in DCI signaling. The CSI reporting triggered may include CSI reporting (e.g., L1 CSI, as one possibility) for at least one non-serving cell, for example for which the wireless device may have received CSI reporting configuration information via MAC CE signaling.

In 506, the wireless device may perform the aperiodic CSI reporting. The CSI measurement and reporting may be performed based at least in part on the configuration information for CSI reporting for non-serving cells received via MAC CE signaling, at least according to some embodiments. For example, this may include receiving a DCI CSI trigger state codepoint configured to be associated with one or more CSI reporting configurations for non-serving cells via MAC CE signaling. As another example, one or more CSI reporting configurations triggered by a DCI CSI trigger state codepoint may have been configured to include one or more CSI resource configurations associated with non-serving cells via MAC CE signaling. As a still further example, one or more CSI resource configurations associated with a CSI reporting configuration triggered by the DCI CSI trigger state codepoint may include a CSI resource set configured to include one or more RS resources associated with non-serving cells via MAC CE signaling.

Thus, at least according to some embodiments, the method of FIG. 5 may be used to update any or all of various aspects of CSI reporting (at any of a variety of possible levels) via MAC CE signaling. This may allow for a wireless device to be quickly re-configured to perform CSI measurements and reporting for neighbor cells with low latency and reduced signaling overhead, and thus to assist a cellular network to more responsively manage and perform handover operations for the wireless device, at least in some instances.

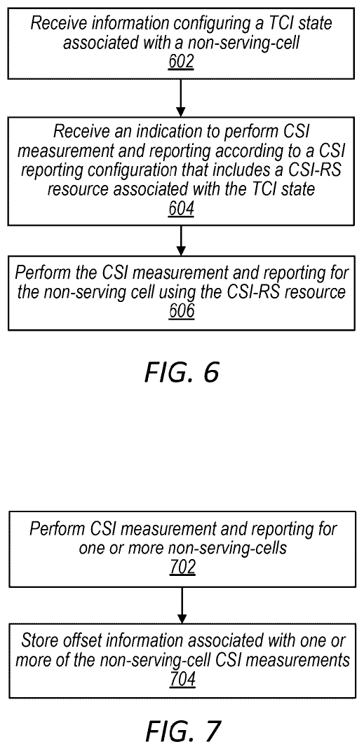

FIG. 6 may relate more particularly to a method for enabling CSI-RS based measurement of non-serving cells by supporting configuring transmission control indicator states for non-serving cell reference signals, according to some embodiments. As shown, in 602, the wireless device may receive TCI state configuration information from the cellular base station serving the wireless device. The TCI state configuration information may configure at least one (“first”) TCI state that is associated with a non-serving cell. For example, the first TCI state may be associated with a synchronization signal block (SSB) resource for the non-serving cell. Note that the TCI state configuration information may also configure one or more other TCI states, which may also be associated with (the same or different) non-serving cells, and/or which may be associated with the serving cell for the wireless device, according to various embodiments.

There may be multiple possible formats in which the cellular base station can provide the TCI state configuration information that configures one or more TCI states associated with non-serving cells to the wireless device. As one possibility, a TCI state list may be provided from the cellular base station to the wireless device that configures both one or more TCI states for the serving cell and one or more TCI states for non-serving cells. As another possibility, multiple TCI state lists may be provided from the cellular base station to the wireless device, where one TCI state list configures one or more TCI states for the serving cell, and another TCI state list configures one or more TCI states for one or more non-serving cells. In such a scenario, it may be the case that all of the TCI states configured for the wireless device for the serving cell may be provided by one TCI state list, while all of the TCI states configured for the wireless device for non-serving cells may be provided by another TCI state list. Thus, if TCI states are configured for multiple non-serving cells, those TCI states may all be grouped together in the TCI state list for non-serving cells. As still another possibility, it may be possible for a TCI state list to be provided for each non-serving cell for which one or more TCI states are configured. Thus, a first TCI state list could be provided from the cellular base station to the wireless device that configures one or more TCI states for a first non-serving cell, a second TCI state list could be provided from the cellular base station to the wireless device that configures one or more TCI states for a second non-serving cell, and so on, for however many non-serving cells for which the cellular base station determines to configure at least one TCI state. Such multiple TCI state lists for non-serving cells may be provided in addition to a TCI state list for the serving cell, at least in some instances.

Note that for any of these approaches, it may be possible that the TCI state configuration information includes cell identification information for non-serving cells for which TCI states are configured. Such identification information could include a physical cell identifier (PCI), which may be a global identifier for a cell, in some embodiments. Alternatively, a logical cell identifier, such as an “additional PCI index” that serves as a localized identifier for a cell, may be used if desired. This may reduce the signaling burden (e.g., as the logical cell identifier may be signaled with less information than the physical cell identifier) for identifying the non-serving cell associated with a TCI state entry, though at a possible cost of supporting a smaller total number of non-serving cells for which TCI states can be configured, at least according to some embodiments.

In 604, the wireless device may receive an indication to perform CSI measurement and reporting for a CSI reporting configuration that includes a CSI-RS resource associated with the first TCI state. In some embodiments, the indication to perform CSI measurement and reporting could include a CSI trigger state codepoint received by the wireless device from the cellular base station via DCI signaling. In a similar manner as described with respect to FIG. 5, at least according to some embodiments, the CSI trigger state codepoint could trigger CSI reporting according to one or more CSI reporting configurations associated with the CSI trigger state codepoint. At least one of those CSI reporting configurations may be associated with a CSI resource configuration that includes a CSI-RS resource set including the CSI-RS resource. The association between the CSI-RS resource and the first TCI state may include that the CSI-RS resource is quasi-co-located (QCL) with the SSB resource associated with the first TCI state, at least in some embodiments.

In 606, the wireless device may perform CSI measurement and reporting for the non-serving cell using the CSI-RS resource. The CSI measurement may include measuring RSRP (e.g., L1 RSRP) and/or any of various other signal strength or signal quality metrics for the non-serving cell using the CSI-RS resource, in some instances. The CSI measurement may also potentially include one or more other RSRP and/or other measurements, for example for other reference signal resources included in the CSI reporting configuration (e.g., that may be associated with other beams of the same non-serving cell, other non-serving cells, and/or the serving cell, among various possibilities). Such information may be used by the cellular base station for any of a variety of possible purposes, potentially including supporting determining whether to perform (and possibly performing) a LTM procedure for the wireless device.

Thus, at least according to some embodiments, the method of FIG. 6 may be used to enable CSI-RS based CSI measurements for non-serving cells. This may allow for a wireless device to be configured to leverage narrower beams of CSI-RS (e.g., compared to SSB) to potentially improve the efficiency of LTM based handover and/or any of various other procedures, at least in some instances.

FIG. 7 may relate more particularly to a method for supporting temporary storage of offset information for non-serving cells after performing CSI measurement and reporting, according to some embodiments. As shown, in 702, the wireless device may perform CSI measurement and reporting for one or more non-serving cells. The CSI measurement and reporting may include measuring RSRP (e.g., L1 RSRP) and/or any of various other signal strength or signal quality metrics for the non-serving cell(s) and reporting the measurements obtained to the cellular base station. In some instances, the CSI measurement and reporting may be performed in accordance with any of the techniques described herein with respect to FIGS. 5-6, among various other possibilities. As part of the CSI measurement, it may be the case that the wireless device obtains offset information (e.g., timing offset and/or frequency offset) for the non-serving cell(s).

In 704, the wireless device may store offset information associated with one or more of the CSI measurements performed for one or more non-serving cells. At least in some embodiments, the amount of offset information stored by the wireless device may be limited, as may be the amount of time for which the offset information is stored, for example to reduce the memory burden on the wireless device to store offset information for non-serving cells (e.g., which may not be immediately useful to the wireless device).

In some embodiments, the wireless device may be configured with a certain capability for storing non-serving cell offset information, and may report such capability to the serving cellular base station as part of wireless device capability reporting. For example, the wireless device may report that it can store offset information up to a certain number of non-serving cell CSI measurements at a time.

In some embodiments, the wireless device may perform offset information storage for non-serving cell CSI measurements based on wireless device configuration and/or standard specifications, e.g., without need for further configuration from the cellular base station. In other embodiments, the cellular base station may provide non-serving cell offset storage configuration information to the wireless device to configure the manner in which the wireless device handles non-serving cell offset storage. In such a scenario, storing the offset information by the wireless device may be performed based at least in part on such non-serving cell offset storage configuration information.

For example, according to some embodiments, it may be the case that the wireless device receives non-serving cell offset storage configuration information that indicates to store offset information for up to a configured number of channel state information measurements (e.g., which may be equal to or lesser than the reported capability of the wireless device, at least in some embodiments) for up to a configured amount of time. The non-serving cell offset storage configuration information may further indicate how to prioritize selection of for which CSI measurements offset information is stored. For example, the non-serving cell offset storage configuration information could indicate to prioritize storing offset information for the largest measured L1 RSRP values from any non-serving cells from the CSI measurements. As another possibility, the non-serving cell offset storage configuration information could indicate to prioritize storing offset information from different non-serving cells in decreasing order of largest measured L1 RSRP values from the CSI measurements. Note that scenarios are also possible in which the wireless device performs prioritization of for which CSI measurements to store offset information without configuration information from the cellular base station (e.g., based on standard specifications, or determined by the wireless device vendor as a design parameter, among various possibilities)

In some embodiments, the non-serving cell offset storage configuration information may indicate a length of a timer associated with storing the offset information. Alternatively, the length of such a timer may be pre-configured/fixed, for example based on standard specifications, or determined as a wireless device design parameter, among various possibilities. The timer may be used to set a limit to the amount of time for which non-serving cell offset information is stored by the wireless device, in some embodiments. For example, a timer for a given set of non-serving cell offset information may be initiated by the wireless device when the corresponding CSI report is provided to the serving cellular base station, and the offset information may be stored for up to the length of the timer, then the stored offset information may be discarded when the timer associated with storing the offset information reaches expiry.

In some embodiments, one or more conditions for stopping the timer (e.g., and potentially using or discarding some or all of the stored non-serving cell offset information) before expiry may also be configured (e.g., by the cellular base station, based on standard specifications, based on wireless device design, etc.). As one such possibility, it may be the case that when the wireless device receives an indication of one or more activated TCI states while the timer associated with storing the offset information is running, the wireless device may discard any stored offset information corresponding to reference signals not associated with an activated TCI state, and may stop the timer based at least in part on receiving the indication of the activated TCI state(s). As another such possibility, it may be the case that when the wireless device receives a cell switch command while the timer associated with storing the offset information is running, the wireless device may discard any stored offset information corresponding to reference signals not associated with a target cell indicated by the cell switch command, and may stop the timer based at least in part on receiving the cell switch command.

At least in some embodiments, if a TCI state is activated for which non-serving cell offset information is stored, the wireless device may be able to use the stored time offset and/or frequency offset information to avoid the need to perform downlink re-synchronization for the TCI state, which may reduce the latency to activate the TCI state. Similarly, in some embodiments, if a cell switch command is provided targeting a cell for which non-serving cell offset information is stored, the wireless device may be able to use the stored time offset and/or frequency offset information to avoid the need to perform downlink re-synchronization for the target cell. Thus, at least according to some embodiments, the method of FIG. 7 may be used to achieve reduced latency for at least some mobility operations, potentially including for at least some LTM procedures.

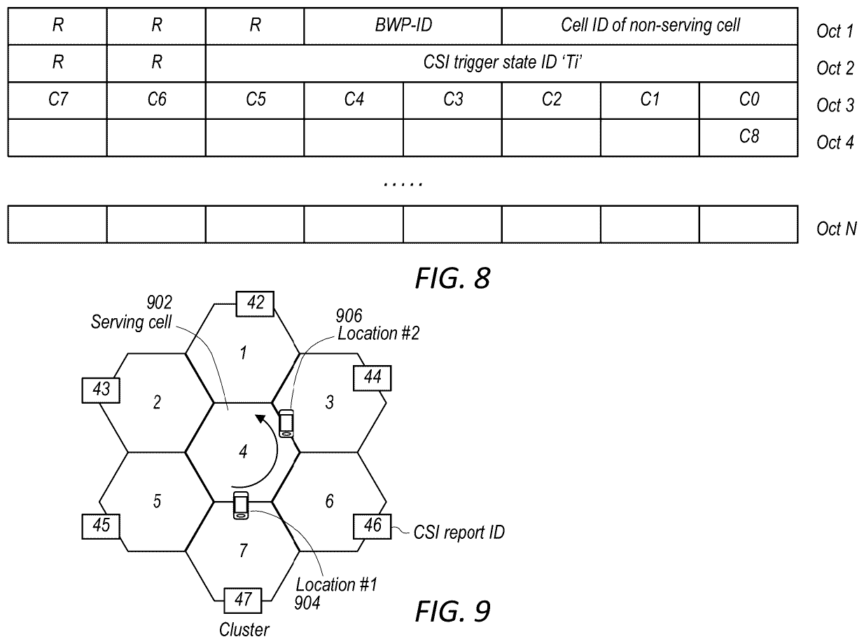

### FIGS. 8-15 and Additional Information

FIGS. 8-15 illustrate further aspects that might be used in conjunction with the methods of FIGS. 5-7 if desired. It should be noted, however, that the exemplary details illustrated in and described with respect to FIGS. 8-15 are not intended to be limiting to the disclosure as a whole: numerous variations and alternatives to the details provided herein below are possible and should be considered within the scope of the disclosure.

Mobile services that require low-latency and high reliability performance (e.g., ultra reliable low latency communication (URLLC) services) are emerging. While the 3GPP 5G standard includes at least some design considerations addressing these use cases, continuing to provide further enhancements to improve mobility robustness performance for existing and newly emerging challenging scenarios may be of significant value.

One area of possible 5G NR mobility enhancements could include layer 1 (L1) enhancements for inter-cell beam management, including L1 measurement and reporting, and beam indication. For example, it may be possible to address any or all of several possible issues for L1 CSI measurement associated with non-serving-cells.

In 3GPP Release 17 inter-cell beam management (ICBM) based CSI measurement, it may be possible for SSBs of non-serving-cells to be added into a CSI measurement resource configuration and for CSI reports for neighbor cells to be obtained accordingly. In at least some NR designs, up to 48 CSI reports can be configured for a serving cell and used for different purposes, e.g., CSI feedback, beam management, time/frequency tracking, etc. In the 3GPP Release 17 ICBM framework, each CSI report may be associated with a CSI resource configuration by RRC signaling. Using RRC signaling may be feasible for CSI feedback used for physical downlink shared channel (PDSCH) scheduling within a serving cell. However, for 3GPP Release 18 L1 L2 triggered mobility (LTM) procedures to reduce handover latency, such a RRC based signaling approach may cause relatively large latency for the CSI resource reconfiguration when a UE moves across different non-serving cells. Accordingly, enhancing the 3GPP Release 17 ICBM framework to enable a faster CSI report and/or resource set update, e.g., to reduce the latency of LTM procedures, may be beneficial in at least some instances.

When performing CSI measurement and reporting for a non-serving cell, it may be the case that using CSI-RS can be more efficient for LTM-based handover than using SSB (e.g., leveraging the narrower beams of the CSI-RS compared to the SSB). However, it may be the case that 3GPP Release 17 based ICBM techniques do not support such use of CSI-RS for CSI measurement and reporting for a non-serving cell, so enhancements to support this may be beneficial in at least some instances.

A UE may need to acquire downlink synchronization with the target cell in order to start communication. Although downlink synchronization may be achieved as part of L1 measurement report generation, it may be the case that a UE does not maintain the timing offset (TO)/frequency offset (FO) estimation information for the measured reference signals, e.g., to minimize buffer size and power consumption, for example since the UE may measure tens of neighbor cells for LTM, at least in some embodiments. As one consequence, a UE may have to re-sync with the network on downlink once it receives a cell switching command. In some embodiments, it may accordingly be beneficial to introduce techniques to reduce the LTM procedure latency by selectively maintaining TO/FO information for certain non-serving-cells that may be candidates for LTM handover to potentially avoid the downlink re-synchronization step.

A variety of approaches may be possible for managing aperiodic CSI (A-CSI) reports associated with non-serving-cells for LTM operations. In some embodiments, for UEs capable of LTM, it may be the case that the maximum number of A-CSI reports configured by RRC signaling may be increased in comparison to UEs that are not capable of LTM. A new MAC CE may be introduced to link the A-CSI reports associated with non-serving cells (which may also be referred to as ‘N-A-CSI’ reports herein) to a CSI trigger state codepoint in downlink control information (DCI). FIG. 8 illustrates an example of such a MAC CE format that can be used to achieve fast CSI trigger state updating for neighbor cell CSI reports, according to some embodiments. The new MAC CE format may include any of a variety of possible fields, and its use may enable a faster association between A-CSI report configuration and A-CSI trigger state (e.g., in comparison to RRC based A-CSI report configuration). The new MAC CE may be identified by a MAC subheader with a dedicated logical channel identifier (LCID). As shown in FIG. 8, at least in some embodiments, it may have fixed size with the following as examples of possible fields.

One field may indicate a cell identifier of the non-serving cell. This field may indicate the ID of the non-serving-cell to which the MAC CE applies. This may include a global cell identifier, in some embodiments. Alternatively, in some designs, the additional PCI index configured by RRC signaling for each non-serving-cell (e.g., a localized logical cell identifier) may be used, e.g., to reduce signaling overhead for the field. In such scenarios, it may be the case that the length of the field can be 3 bits, at least in some embodiments.

Another field may include a bandwidth part identifier (BWP-ID), which may indicate the downlink BWP with which the CSI report is associated. In some designs, it may be possible that the BWP of the non-serving cell in LTM may be fixed (hard-encoded) in standard specifications, in which case it may be possible that such an information element (IE) is not present in the MAC CE.

Still another field may include a CSI trigger state identifier ‘Tᵢ’, which may indicate the CSI trigger state codepoint to which the MAC CE applies. A set of fields ‘Cⱼ’ may also be included to indicate the associated A-CSI reports that are selected for the corresponding CSI trigger state value Tᵢ. For example, for each Cⱼ field, a value of ‘1’ may indicate that the A-CSI report with CSI report ID ‘j’ is associated with the CSI trigger state value Tᵢ. Note that, in this design, it may be the case that the A-CSI report with CSI report ID j may be associated with a serving or non-serving cell. As another option, the CSI report association update MAC CE may be limited to use for N-A-CSI reports only. For example, the N-A-CSI reports configured for a UE may be grouped into a N-A-CSI report group. The N-A-CSI reports within the N-A-CSI report group may be indexed starting from ‘0’ in order of increasing A-CSI report ID. In this case, the Cⱼ field being set to 1 may indicate that the A-CSI report with N-A-CSI report ID j within the N-A-CSI report group is associated with the CSI trigger state value Tᵢ.

As shown, it may also be the case that several reserved bits (e.g., bits 5, 6, 7 of octet 1, bits 6, 7 of octet 2) are included in the A-CSI trigger state fast update MAC CE. Note that while the illustrated format represents one possible format, other formats are also possible. For example, a format extension for updating a trigger state codepoint to be associated with N-A-CSI reports associated with multiple non-serving cells may be possible in some embodiments. Such a format extension could include providing BWP-ID, cell ID, and Cⱼ field sets for each relevant cell for a given CSI trigger state value Tᵢ, at least as one possibility.

FIG. 9 illustrates aspects of an example scenario in which such a fast CSI triggering update MAC CE can be used, according to some embodiments. In the illustrated example, the serving cell 902 ID may be ‘4’, and six neighbor cells may be configured for A-CSI reports. It may be assumed in the example that 48 CSI reports are configured in total for the serving cell and neighbor cells; CSI reports ID #0-41 may be associated with the serving cell, while CSI reports ID #42-47 may be one-to-one associated with each non-serving cell (i.e., may be associated with N-A-CSI reports). If the A-CSI report with CSI report ID j may be associated with a serving or non-serving cell, it may be the case that 8 octets are needed for the A-CSI trigger state fast update MAC CE (e.g., N=2+48/8=8), at least according to some embodiments. If the A-CSI trigger state fast update MAC CE is limited to use for N-A-CSI reports only, it may be the case that 3 octets are needed (e.g., N=2+[6/8]=3), at least according to some embodiments.

Consider a scenario in which the network first associates the CSI trigger state ‘010’ with the following A-CSI reports when the UE is located at position #1 904: CSI report #45 for cell #5; CSI report #46 for cell #6; CSI report #47 for cell #7. When the UE moves to location #2 906, the network may be able to update the CSI reports associated with the same CSI trigger state ‘010’ using the fast CSI triggering update MAC CE format, e.g., instead of performing RRC reconfiguration, to the following: CSI report #42 for cell #1; CSI report #43 for cell #2; CSI report #44 for cell #3. Note that in order to update multiple non-serving cells using the proposed fast CSI triggering update MAC CE format, it may be possible that multiple such update MAC CEs (e.g., one for each non-serving cell) is provided. Alternatively, as previously noted, it may be possible for such a MAC CE to include BWP-ID, cell ID, and Cⱼ field sets for each relevant cell for a given CSI trigger state value Tᵢ, e.g., in order to support updating a CSI trigger state value Tᵢ to trigger multiple CSI reports associated with multiple different non-serving-cells using a single MAC CE.

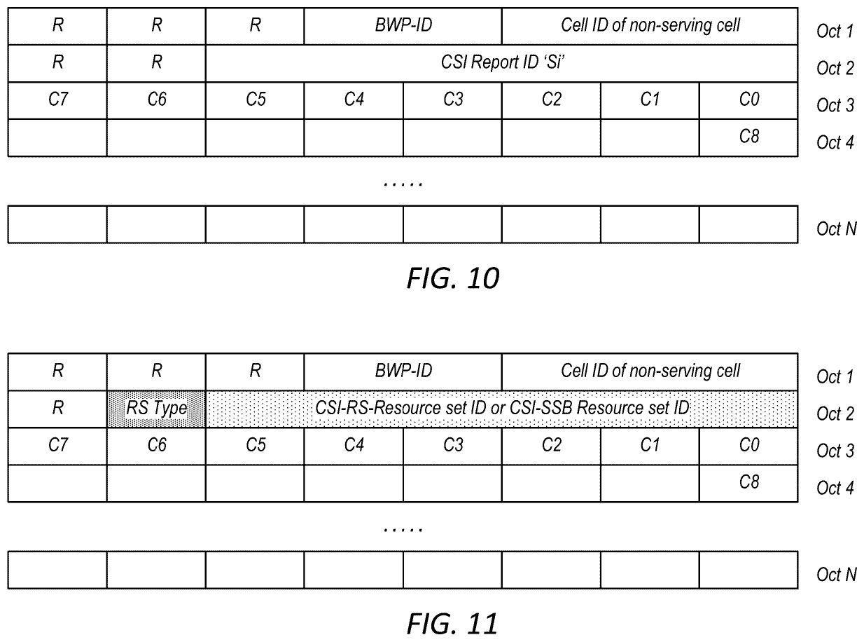

A fast CSI Report update MAC CE format may also or alternatively be used, e.g., to map a CSI resource configuration to a CSI report ID more quickly than using RRC signaling, according to some embodiments. FIG. 10 illustrates an example of such a MAC CE format that can be used to achieve fast CSI resource configuration to CSI report ID mapping updating, according to some embodiments. The new MAC CE may be identified by a MAC subheader with a dedicated LCID. As shown in FIG. 10, at least in some embodiments, it may have fixed size with the following as examples of possible fields.

Fields may be included for indicating a cell identifier of the non-serving cell, and for indicating a BWP-ID, according to some embodiments. Such fields may operate in a similar manner as in the example A-CSI trigger state fast update MAC CE format illustrated in and described with respect to FIG. 8, at least as one possibility.

In addition, a CSI report configuration ID field ‘Sᵢ’ may be included to indicate the ID that identifies a unique CSI report configuration. A set of CSI resource configuration ID fields Cⱼ may each indicate the ID that identifies a unique CSI resource configuration. The set of fields ‘Cⱼ’ may be used to indicate the associated CSI resource configurations that are selected for the corresponding CSI report ID Sᵢ. For example, for each Cⱼ field, a value of ‘1’ may indicate that the CSI resource configuration with CSI resource configuration ID ‘j’ is associated with the CSI report ID Sᵢ. Note that, in this design, it may be the case that the CSI report configuration IDs and CSI Resource configuration IDs provided by RRC signaling are directly used in the MAC CE. As another option, group based resource and report indexing may be used, e.g., to reduce the MAC CE payload size and signaling overhead. For example, the CSI report configurations or the CSI resource configurations that are associated with non-serving cells may be formed into a group, and may be indexed within the same group starting from ‘0’ in order of increasing ID value. The new ID indexing within the group may then be used in the MAC CE indication. Thus, for example, in such a scenario, the Cⱼ field being set to 1 may indicate that the CSI resource configuration indexed to CSI resource configuration ID j within the group of non-serving-cell CSI resource configurations is associated with the CSI report configuration ID Sᵢ.

Considering again the example scenario illustrated in FIG. 9, for example, the CSI reports ID #0-41 and CSI Resource configurations #0-41 may be associated with the serving cell, while CSI reports ID #42-47 and CSI Resource configurations #42-47 may be one-to-one associated with each non-serving cell. In such a case, if the CSI report configuration IDs and CSI Resource configuration IDs provided by RRC signaling are directly used in the MAC CE, it may be the case that 8 octets are needed for the fast CSI Report update MAC CE, while if group based resource and report indexing is used, it may be the case that 3 octets are needed, at least according to some embodiments.

As shown, it may also be the case that several reserved bits (e.g., bits 5, 6, 7 of octet 1, bits 6, 7 of octet 2) are included in the fast CSI Report update MAC CE. Note that while the illustrated format represents one possible format, other formats are also possible. For example, a format extension for updating a CSI report ID to be associated with CSI resource configurations associated with multiple non-serving cells may be possible in some embodiments. Such a format extension could include providing BWP-ID, cell ID, and Cⱼ field sets for each relevant cell for a given CSI report ID Si, at least as one possibility.

In some embodiments, a MAC CE may be used to update the associated reference signal (RS) resources (e.g., SSB or CSI-RS resource) for a given CSI resource set. Similar to the example fast CSI triggering update and fast CSI Report update MAC CE formats described herein, it may be the case that the size of the MAC CE is fixed and identified by a dedicated LCID (or extended LCID (ELCID)) for such a fast CSI resource set update MAC CE format. FIG. 11 illustrates an example of such a MAC CE format that can be used to achieve fast CSI resource set updating, according to some embodiments.

Fields may be included for indicating a cell identifier of the non-serving cell, and for indicating a BWP-ID, according to some embodiments. Such fields may operate in a similar manner as in the example A-CSI trigger state fast update MAC CE format illustrated in and described with respect to FIG. 8, at least as one possibility.

In addition, a RS type field (e.g., 1 bit) may be used to indicate the RS type being updated. For example, a value of ‘0’ could be defined to indicate a CSI-RS-Resource set and a value of ‘1’ could be defined to indicate a CSI-SSB-Resource set. A CSI-RS-Resource set ID or CSI-SSB-Resource set ID field may be used to indicate the CSI resource set ID to which the MAC CE applies. A set of NZP-CSI-RS Resource ID or SSB Indices ‘Cᵢ’ may indicate the NZP-CSI-RS resource(s) or SSB resource(s) associated with the non-serving cell in the same MAC CE. Note that the number of SSBs may depend on the frequency range in which the cell is deployed; for example, in some embodiments, up to 8 SSBs may be configured for 3GPP frequency range 1 (FR1) and up to 64 SSBs may be configured for 3GPP frequency range 2 (FR2).

As previously noted, in some embodiments, it may be useful to support use of CSI-RS for CSI measurement and reporting for a non-serving cell. A variety of approaches to supporting CSI-RS based CSI reporting associated with non-serving-cells (e.g., for LTM operation) may be possible. In some instances, such techniques may include providing a UE with a set of TCI-states, where each TCI-state (or at least a subset of the TCI-states) is associated with a SSB on a non-serving-cell. Note that to differentiate these TCI-states from TCI-states associated with a serving cell, a TCI-state associated with a non-serving cell may also be referred to as a ‘N-TCI-state’ herein.

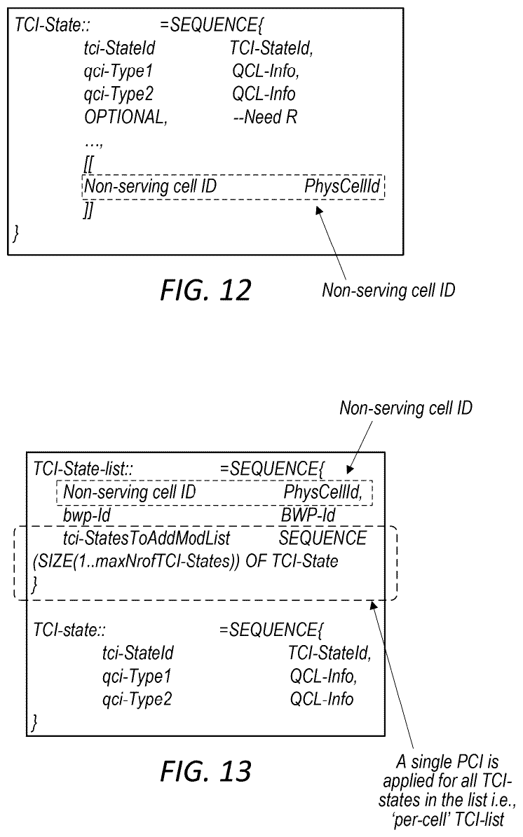

In some embodiments, such N-TCI-states may be provided within a TCI-state list that can include both TCI-states and N-TCI-states. FIG. 12 illustrates example ASN.1 code that could be used for such N-TCI-state configuration, according to some embodiments. As shown, non-serving-cell ID or a ‘virtual’ ID that identifies the serving cell may be included. In some designs, the ‘additional PCI Index’ (e.g., logical cell ID) associated with a non-serving-cell may be used in N-TCI-state configuration to link it with a particular non-serving cell, e.g., to reduce overhead in comparison to using a global cell identifier.

As another possibility, a UE may be provided with a separate TCI-states list that only includes N-TCI-states, and which may include all configured N-TCI-states (e.g., that can include those associated with any or all non-serving cells).

As a still further possibility, a separate N-TCI-states list may be configured (e.g., by RRC signaling) for each non-serving cell independently. In other words, it may be the case that a TCI-states list is configured for the serving cell as well as for each non-serving cell for which TCI-states or N-TCI-states are being configured. FIG. 13 illustrates example ASN.1 code that could be used for such N-TCI-state configuration, according to some embodiments. As shown, it may be the case that a single PCI is applied for all N-TCI-states in the list; said another way, in such an approach, per-cell TCI-list information may be provided.

Note that for any or all of these N-TCI-state provision approaches, it may be the case that the ‘non-serving cell ID’ indicates the physical cell IDs (PCIs) of the SSBs when referenceSignal is configured as SSB for both QCL-Type1 and QCL-Type2, at least according to some embodiments.

As also previously noted herein, it may be possible to use any of a variety of approaches to temporarily retain at least some estimated time (TO) offset and/or frequency offset (FO) information measured on a given reference signal of a non-serving cell. Such TO/FO retention techniques may be useful if a UE is performing CSI reporting for LTM operation, for example, to potentially reduce or avoid the need to perform downlink synchronization for LTM handover, which may reduce handover signaling overhead and/or latency.

To balance such potential benefits with possible memory/buffer costs, it may be useful to provide techniques for selecting a limited number of RSs and/or a limited time period for which TO/FO information is retained. In some embodiments, it may be possible that the number of TO/FO parameters and corresponding RSs (denoted as ‘M’) that a UE can maintain for neighbor cells after measurement is reported to the network in UE capability information.

In some embodiments, the network may configure (e.g., using RRC signaling) a UE to retain TO/FO information for up to ‘N’ (where N≤M) largest measured non-serving-cell L1-RSRP values, once they are reported. As another possibility, the network may configure a UE to retain TO/FO information for up to ‘N’ (where N≤M) non-serving-cells, selected in decreasing order of the largest measured non-serving-cell L1-RSRP values, once they are reported. As still another possibility, a UE may be configured (e.g., based on Standard specifications and/or device design, possibly without explicit network configuration) to always maintain TO/FO information for the M largest measured L1-RSRP values or for M non-serving cells selected in decreasing order of the largest measured L1-RSRP values.

It may be the case that retention of such TO/FO information for non-serving cells is limited by one or more conditions. In some embodiments, a timer (e.g., timer ‘T610,’ as one possibility) may be introduced, which may be operated as follows. The timer may start upon transmission of a CSI report that includes the relevant L1-RSRP results. In some instances, the timer may be stopped prior to expiry upon reception of a MAC CE that updates the unified TCI-states. In such a scenario, it may be the case that the UE discards the TO/FO value(s) stored if the corresponding RS(s) is (are) not associated with any activated TCI-states. In some instances, the timer may be stopped prior to expiry upon reception of a cell-switch command MAC CE. In such a scenario, it may be the case that the UE discards the TO/FO value(s) stored if the corresponding RS(s) is (are) not associated with the target cell indicated by the cell switch command. Upon timer expiry, it may be the case that the UE discards all of the stored TO/FO values associated with the reported L1-RSRP in the recent instance. Note that the length of the timer may be configured by RRC signaling or hard-encoded in Standard specifications, in various embodiments.

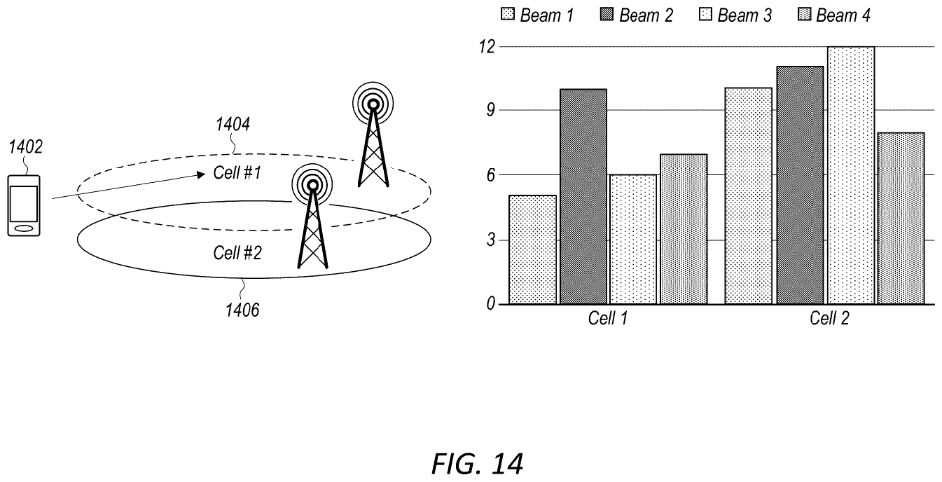

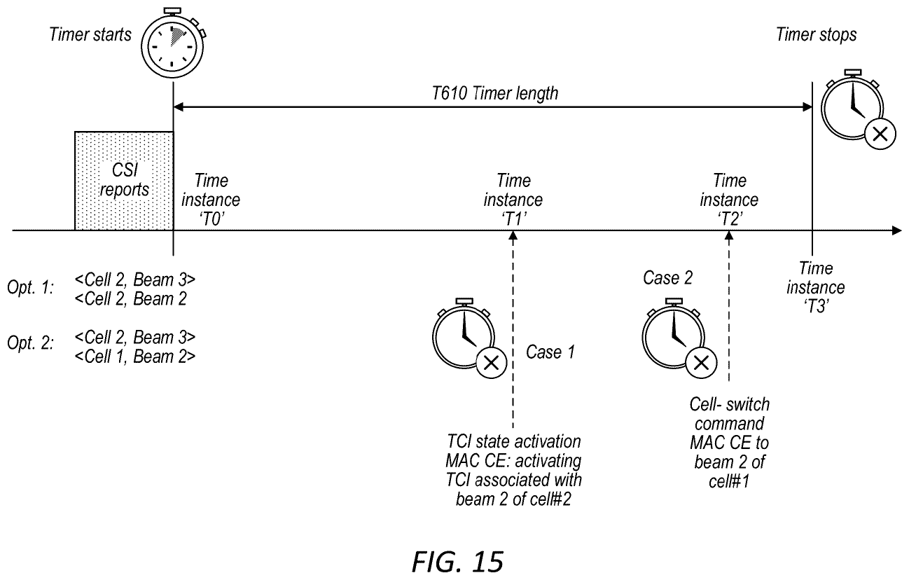

FIGS. 14-15 illustrate various aspects of an example scenario in which TO/FO information is retained for a limited time period to potentially reduce LTM handover latency, according to some embodiments. As shown in FIG. 14, in the illustrated example scenario, a UE 1402 may have 2 candidate cells, cell #1 1404 and cell #2 1406, where each cell is operating with 4 beams, with the measured L1-RSRP values for the different beams depicted. As shown in FIG. 15, a timer T610 may start at the end symbol of the physical uplink shared channel (PUSCH) transmission with the CSI reports.

While the timer T610 is running, if the UE is configured to store TO/FO information for up to N=2 largest measured non-serving-cell L1-RSRP values (“Option 1”), the TO/FO associated with beam #2 and beam #3 of cell #2 may be stored. Alternatively, if the UE is configured to store TO/FO information for up to N=2 non-serving-cells (“Option 2”), selected in decreasing order of the largest measured non-serving-cell L1-RSRP values, the TO/FO associated with beam #3 of cell #2 and beam #2 of cell #1 may be stored.

In a first scenario (“Case 1”), at time instance ‘T1’, the UE may receive a TCI-state activation MAC CE that activates the TCI state associated with beam #2 of cell #2, and the UE may correspondingly stop maintaining the TO/FOs associated with any other beams except beam #2 of cell #2. Note that in this case, in “Option 1”, the stored TO/FO information for beam #2 of cell #2 may be available for use for the TCI state activation, while in “Option 2”, since stored TO/FO information may not be available for beam #2 of cell #2, the UE may need to perform downlink TO/FO re-synchronization.

In a second scenario (“Case 2”), at time instance ‘T2’, the UE may receive a cell-switch command that indicates handover to beam #2 of cell #1, and the UE may correspondingly stop maintaining the TO/FOs associated with any other beams except beam #2 of cell #1. Note that in this case, in “Option 2”, the stored TO/FO information for beam #2 of cell #1 may be available for use for the cell-switch, while in “Option 1”, since stored TO/FO information may not be available for beam #2 of cell #1, the UE may need to perform downlink TO/FO re-synchronization.

In a third scenario (“Case 3”), at time instance ‘T3’, the timer T610 may expire. In this case, the UE may stop maintaining all the TO/FOs associated with non-serving cells, including cell #1 and cell #2.

In the following further exemplary embodiments are provided.

One set of embodiments may include a method, comprising: by a wireless device: establishing a wireless link with a cellular base station, wherein the cellular base station configures a serving cell and one or more non-serving cells for the wireless device via radio resource control (RRC) signaling; receiving channel state information (CSI) reporting configuration information for the serving cell and the one or more non-serving cells from the cellular base station via RRC signaling; receiving media access control (MAC) control element (CE) signaling to update an association between one or more CSI reporting configurations and a codepoint value of a CSI trigger state field; receiving a CSI trigger state field indication triggering aperiodic CSI reporting from the cellular base station, wherein the CSI reporting triggered includes CSI reporting for at least one non-serving cell; and performing the aperiodic CSI reporting for the at least one non-serving cell based at least in part on the MAC CE signaling received to update the association between the one or more CSI reporting configurations and the codepoint value of the CSI trigger state field.

According to some embodiments, the MAC CE signaling configures one or more CSI reporting configurations to be associated with a codepoint value of a CSI trigger state field in a downlink control information (DCI).

According to some embodiments, the one or more CSI reporting configurations updated to be associated with the codepoint value of the CSI trigger state codepoint in the DCI are identified in the MAC CE signaling using CSI reporting configuration IDs provided for the CSI reporting configurations by RRC signaling.

According to some embodiments, the method further comprises: receiving an indication of a set of CSI reporting configuration IDs via RRC signaling, wherein the set of CSI reporting configuration IDs include CSI reporting configuration IDs associated with the serving cell and CSI reporting configuration IDs associated with non-serving-cells; determining which CSI reporting configuration IDs are associated with non-serving-cells; and determining non-serving-cell group index based identifiers for the CSI reporting configuration IDs that are associated with non-serving cells, wherein the one or more CSI reporting configurations configured to be associated with the codepoint value of a CSI trigger state field in the DCI are identified in the MAC CE signaling using the non-serving-cell group index based identifiers.

According to some embodiments, the MAC CE signaling configures one or more CSI resource configurations to be associated with a CSI reporting configuration.

According to some embodiments, the one or more CSI resource configurations are identified in the MAC CE signaling using CSI resource configuration IDs provided by RRC signaling, wherein the CSI reporting configuration is identified in the MAC CE signaling using a CSI reporting configuration ID provided by RRC signaling.

According to some embodiments, wherein the method further comprises: receiving an indication of a set of CSI reporting configuration IDs via RRC signaling, wherein the set of CSI reporting configuration IDs include CSI reporting configuration IDs associated with the serving cell and CSI reporting configuration IDs associated with non-serving-cells; determining which CSI reporting configuration IDs are associated with non-serving-cells; and determining non-serving-cell group index based identifiers for the CSI reporting configuration IDs that are associated with non-serving cells, wherein the CSI reporting configuration is identified in the MAC CE signaling using a non-serving-cell group index based identifier.

According to some embodiments, wherein the method further comprises: receiving an indication of a set of CSI resource configuration IDs via RRC signaling, wherein the set of CSI resource configuration IDs include CSI resource configuration IDs associated with the serving cell and CSI resource configuration IDs associated with non-serving-cells; determining which CSI resource configuration IDs are associated with non-serving-cells; and determining non-serving-cell group index based identifiers for the CSI resource configuration IDs that are associated with non-serving cells, wherein the one or more CSI resource configurations configured to be associated with the CSI reporting configuration are identified in the MAC CE signaling using the non-serving-cell group index based identifiers.

According to some embodiments, the MAC CE signaling configures one or more reference signal (RS) resources to be associated with a CSI resource set.

According to some embodiments, the MAC CE signaling indicates a reference signal type for the RS resources to be associated with the CSI resource set, wherein the reference signal type is selected from CSI-RS or synchronization signal block (SSB) signal, wherein the MAC CE signaling indicates a CSI-RS resource set ID or CSI-SSB resource set ID of the CSI resource set, wherein the MAC CE signaling indicates one or more NZP-CSI-RS resource IDs or SSB indices.

According to some embodiments, the MAC CE signaling indicates a non-serving cell identifier and bandwidth part identifier associated with the one or more CSI reporting configurations.

Another set of embodiments may include an apparatus, comprising: a processor configured to cause a wireless device to: establish a wireless link with a cellular base station, wherein the cellular base station configures a serving cell and one or more non-serving cells for the wireless device via radio resource control (RRC) signaling; receive channel state information (CSI) reporting configuration information from the cellular base station via RRC signaling; receive media access control (MAC) control element (CE) signaling to update an association between one or more CSI reporting configurations and a codepoint value of a CSI trigger state field; receive a CSI trigger state field indication triggering aperiodic CSI reporting from the cellular base station; and perform CSI measurement and reporting to the cellular base station based at least in part on the MAC CE signaling received to update the association between the one or more CSI reporting configurations and the codepoint value of the CSI trigger state field.

According to some embodiments, the MAC CE signaling configures one or more CSI reporting configurations associated with non-serving cells to be associated with a codepoint value of a CSI trigger state field in a downlink control information (DCI), wherein receiving the indication triggering the aperiodic CSI reporting includes receiving indication of the CSI trigger state codepoint via DCI signaling.

According to some embodiments, the MAC CE signaling configures one or more CSI resource configurations associated with non-serving cells to be associated with a CSI reporting configuration, wherein the indication triggering the aperiodic CSI reporting indicates to use the CSI reporting configuration to perform the CSI reporting.

According to some embodiments, the MAC CE signaling configures one or more reference signal (RS) resources associated with non-serving cells to be associated with a CSI resource set, wherein the indication triggering the aperiodic CSI reporting indicates to use a CSI reporting configuration that includes use of the CSI resource set to perform the CSI reporting.

Yet another set of embodiments may include a cellular base station, comprising: an antenna; a radio operably coupled to the antenna; and a processor operably coupled to the radio; wherein the cellular base station is configured to: establish a wireless link with a wireless device, wherein the cellular base station configures a serving cell and one or more non-serving cells for the wireless device via radio resource control (RRC) signaling; provide channel state information (CSI) reporting configuration information for the serving cell and the one or more non-serving cells to the wireless device via RRC signaling; provide media access control (MAC) control element (CE) signaling to update an association between one or more CSI reporting configurations and a codepoint value of a CSI trigger state field; provide a CSI trigger state field indication triggering aperiodic CSI reporting to the wireless device, wherein the CSI reporting triggered includes CSI reporting for at least a first non-serving cell; and receive CSI reporting for the first non-serving cell from the wireless device, wherein the CSI reporting for the first non-serving cell is performed based at least in part on the MAC CE signaling provided to update the association between the one or more CSI reporting configurations and the codepoint value of the CSI trigger state field.

According to some embodiments, the MAC CE signaling configures one or more CSI reporting configurations associated with non-serving cells to be associated with a CSI trigger state codepoint in the downlink control information (DCI), wherein providing the indication triggering the aperiodic CSI reporting includes providing an indication of the CSI trigger state codepoint via DCI signaling.

According to some embodiments, the MAC CE signaling configures one or more CSI resource configurations associated with non-serving cells to be associated with a CSI reporting configuration, wherein the indication triggering the aperiodic CSI reporting indicates to use the CSI reporting configuration to perform the CSI reporting.

According to some embodiments, the MAC CE signaling configures one or more reference signal (RS) resources associated with non-serving cells to be associated with a CSI resource set, wherein the indication triggering the aperiodic CSI reporting indicates to use a CSI reporting configuration that includes use of the CSI resource set to perform the CSI reporting.

According to some embodiments, the MAC CE signaling indicates a non-serving cell identifier and bandwidth part identifier associated with the one or more CSI reporting configurations.

Still another set of embodiments may include a method, comprising: by a wireless device: establishing a wireless link with a cellular base station, wherein the cellular base station provides a serving cell and one or more non-serving cells for the wireless device; receiving transmission control indicator (TCI) state configuration information from the cellular base station, wherein the TCI state configuration information configures at least a first TCI state that is associated with a non-serving-cell; receiving an indication to perform channel state information (CSI) measurement and reporting for a CSI reporting configuration that includes a CSI-reference signal (CSI-RS) resource associated with the first TCI state; and performing CSI measurement and reporting for the non-serving cell using the CSI-RS resource.

According to some embodiments, the method further comprises: receiving a TCI state list from the cellular base station that configures one or more TCI states for the serving cell and one or more TCI states for non-serving-cells, wherein the TCI state list configures the first TCI state.

According to some embodiments, the method further comprises: receiving a first TCI state list from the cellular base station that configures one or more TCI states for the serving cell; and receiving a second TCI state list from the cellular base station that configures one or more TCI states for one or more non-serving-cells, wherein the second TCI state list configures the first TCI state.

According to some embodiments, the method further comprises: receiving a first TCI state list from the cellular base station that configures one or more TCI states for a first non-serving-cell; and receiving a second TCI state list from the cellular base station that configures one or more TCI states for a second non-serving-cell, wherein one of the first TCI state list or the second TCI state list configures the first TCI state.

According to some embodiments, the non-serving cell is identified in the TCI state configuration information using a physical cell identifier.

According to some embodiments, the non-serving cell is identified in the TCI state configuration information using a logical cell identifier that is provided by radio resource control (RRC) signaling.

According to some embodiments, the first TCI state is associated with a synchronization signal block (SSB) resource for the non-serving cell, wherein the CSI-RS resource is quasi-co-located (QCL) with the SSB resource.

A further set of embodiments may include an apparatus, comprising: a processor configured to cause a wireless device to: establish a wireless link with a cellular base station, wherein the cellular base station provides a serving cell and one or more non-serving cells for the wireless device; receive transmission control indicator (TCI) state configuration information from the cellular base station, wherein the TCI state configuration information configures at least a first TCI state that is associated with a non-serving-cell; receive an indication to perform channel state information (CSI) measurement and reporting for a CSI reporting configuration that includes a CSI-reference signal (CSI-RS) resource associated with the first TCI state; and perform channel state information measurement and reporting for the non-serving cell using the CSI-RS resource.

According to some embodiments, the TCI state configuration information includes a TCI state list that configures one or more TCI states for the serving cell and one or more TCI states for non-serving-cells.

According to some embodiments, the TCI state configuration information includes a TCI state list that configures one or more TCI states for the serving cell; wherein the TCI state configuration information includes a separate TCI state list that configures at least one TCI state for each of at least two non-serving-cells.

According to some embodiments, the TCI state configuration information includes a TCI state list that configures one or more TCI states for a first non-serving-cell, wherein the TCI state configuration information includes a separate TCI state list that configures one or more TCI states for a second non-serving-cell.

According to some embodiments, the non-serving cell is identified in the TCI state configuration information using one of: a physical cell identifier; or a logical cell identifier that is provided by radio resource control (RRC) signaling.

According to some embodiments, the first TCI state is associated with a synchronization signal block (SSB) resource for the non-serving cell, wherein the CSI-RS resource is quasi-co-located (QCL) with the SSB resource.

A still further set of embodiments may include a cellular base station, comprising: an antenna; a radio operably coupled to the antenna; and a processor operably coupled to the radio; wherein the cellular base station is configured to: establish a wireless link with a wireless device, wherein the cellular base station provides a serving cell and one or more non-serving cells for the wireless device; provide transmission control indicator (TCI) state configuration information to the wireless device, wherein the TCI state configuration information configures at least a first TCI state that is associated with a non-serving-cell; provide an indication to the wireless device to perform channel state information (CSI) measurement and reporting for a CSI reporting configuration that includes a CSI-reference signal (CSI-RS) resource associated with the first TCI state; and receive CSI information from the wireless device, wherein the CSI information includes CSI reporting for the non-serving cell using the CSI-RS resource.

According to some embodiments, the cellular base station is further configured to: provide a TCI state list to the wireless device that configures one or more TCI states for the serving cell and one or more TCI states for non-serving-cells, wherein the TCI state list configures the first TCI state.

According to some embodiments, the cellular base station is further configured to: provide a first TCI state list to the wireless device that configures one or more TCI states for the serving cell; and provide a second TCI state list to the wireless device that configures one or more TCI states for one or more non-serving-cells, wherein the second TCI state list configures the first TCI state.

According to some embodiments, the cellular base station is further configured to: provide a first TCI state list to the wireless device that configures one or more TCI states for a first non-serving-cell; and provide a second TCI state list to the wireless device that configures one or more TCI states for a second non-serving-cell, wherein one of the first TCI state list or the second TCI state list configures the first TCI state.

According to some embodiments, the non-serving cell is identified in the TCI state configuration information using a physical cell identifier.

According to some embodiments, the non-serving cell is identified in the TCI state configuration information using a logical cell identifier that is provided by radio resource control (RRC) signaling.

According to some embodiments, the first TCI state is associated with a synchronization signal block (SSB) resource for the non-serving cell, wherein the CSI-RS resource is quasi-co-located (QCL) with the SSB resource.

Yet another set of embodiments may include a method, comprising: by a wireless device: establishing a wireless link with a cellular base station, wherein the cellular base station provides a serving cell and one or more non-serving cells for the wireless device; performing channel state information measurement and reporting for one or more non-serving cells; and storing timing and frequency offset information associated with one or more of the channel state information measurements performed for the one or more non-serving cells.

According to some embodiments, the method further comprises: providing wireless device capability information to the cellular base station, wherein the wireless device capability information indicates a number of reference signals for which the wireless device can store timing and frequency offset information associated with non-serving cells.

According to some embodiments, the method further comprises: receiving non-serving cell timing and frequency offset storage configuration information from the cellular base station, wherein the non-serving cell timing and frequency offset storage configuration information indicates to store timing and frequency offset information for up to a configured number of channel state information measurements for up to a configured amount of time, wherein storing the timing and frequency offset information is based at least in part on the non-serving cell timing and frequency offset storage configuration information.

According to some embodiments, the non-serving cell offset timing and frequency storage configuration information indicates to prioritize storing timing and frequency offset information for reference signals received with largest measured layer one reference signal received power (L1-RSRP) values from any non-serving cells from the channel state information measurement.

According to some embodiments, the non-serving cell timing and frequency offset storage configuration information indicates to prioritize storing timing and frequency offset information from different non-serving cells in decreasing order of largest measured layer one reference signal received power (L1-RSRP) values from the channel state information measurement.

According to some embodiments, the method further comprises: initiating a timer associated with storing the timing and frequency offset information, wherein the timing and frequency offset information is stored for up to a length of the timer associated with storing the timing and frequency offset information; and discarding the stored timing and frequency offset information when the timer associated with storing the timing and frequency offset information reaches expiry.

According to some embodiments, the method further comprises: receiving an indication of one or more activated TCI states while the timer associated with storing the timing and frequency offset information is running; and discarding any stored timing and frequency offset information corresponding to reference signals not associated with an activated TCI state and stopping the timer associated with storing the timing and frequency offset information based at least in part on receiving the indication of the one or more activated TCI states while the timer associated with storing the timing and frequency offset information is running.

According to some embodiments, the method further comprises: receiving a cell-switch command while the timer associated with storing the timing and frequency offset information is running; and discarding any stored timing and frequency offset information corresponding to reference signals not associated with a target cell indicated by the cell switch command and stopping the timer associated with storing the timing and frequency offset information based at least in part on receiving the indication of the cell-switch command while the timer associated with storing the timing and frequency offset information is running.

Still another set of embodiments may include an apparatus, comprising: a processor configured to cause a wireless device to: establish a wireless link with a cellular base station, wherein the cellular base station provides a serving cell for the wireless device; perform channel state information measurement and reporting for one or more non-serving cells; and store offset information associated with one or more of the channel state information measurements performed for the one or more non-serving cells.

According to some embodiments, the processor is further configured to cause the wireless device to: provide wireless device capability information to the cellular base station, wherein the wireless device capability information indicates a number of non-serving cell reference signals for which the wireless device can store offset information.

According to some embodiments, the processor is further configured to cause the wireless device to: determine to prioritize storing offset information for largest measured layer one (L1) reference signal received power (RSRP) values from any non-serving cells from the channel state information measurement up to a non-serving cell offset storage capability for the wireless device.

According to some embodiments, the processor is further configured to cause the wireless device to: determine to prioritize storing offset information from different non-serving cells in decreasing order of largest measured layer one (L1) reference signal received power (RSRP) values from the channel state information measurement up to a non-serving cell offset storage capability for the wireless device.

According to some embodiments, the processor is further configured to cause the wireless device to: initiate a timer associated with storing the offset information, wherein the offset information is stored for up to a length of the timer; and discard the stored offset information when the timer associated with storing the offset information reaches expiry.

According to some embodiments, the processor is further configured to cause the wireless device to: receive non-serving cell offset storage configuration information from the cellular base station, wherein the non-serving cell offset storage configuration information configures the length of the timer associated with storing non-serving cell offset information for the wireless device.

According to some embodiments, the offset information includes one or more of timing offset information or frequency offset information.

A yet further set of embodiments may include a cellular base station, comprising: an antenna; a radio operably coupled to the antenna; and a processor operably coupled to the radio; wherein the cellular base station is configured to: establish a wireless link with a wireless device, wherein the cellular base station provides a serving cell and one or more non-serving cells for the wireless device; receive wireless device capability information from the wireless device, wherein the wireless device capability information indicates a number of non-serving cell reference signals for which the wireless device can store offset information; provide non-serving cell offset storage configuration information to the wireless device, wherein the non-serving cell offset storage configuration information indicates to store offset information for up to a configured number of channel state information measurements for up to a configured amount of time duration; and configure the wireless device to perform channel state information measurement and reporting for one or more non-serving cells.

According to some embodiments, the non-serving cell offset storage configuration information indicates to prioritize storing offset information for largest measured layer one (L1) reference signal received power (RSRP) values from any non-serving cells from the channel state information measurement.

According to some embodiments, the non-serving cell offset storage configuration information indicates to prioritize storing offset information from different non-serving cells in decreasing order of largest measured layer one (L1) reference signal received power (RSRP) values from the channel state information measurement.

According to some embodiments, the non-serving cell offset storage configuration information configures a timer associated with storing non-serving cell offset information for the wireless device.

According to some embodiments, the offset information includes one or more of timing offset information or frequency offset information.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processor configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory clement) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory clement), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
by a wireless device:
establishing a wireless link with a cellular base station, wherein the cellular base station configures a serving cell and one or more non-serving cells for the wireless device via radio resource control (RRC) signaling;
receiving channel state information (CSI) reporting configuration information for the serving cell and the one or more non-serving cells from the cellular base station via RRC signaling;
receiving media access control (MAC) control element (CE) signaling to update an association between one or more CSI reporting configurations and a codepoint value of a CSI trigger state field;
receiving a CSI trigger state field indication triggering aperiodic CSI reporting from the cellular base station, wherein the CSI reporting triggered includes CSI reporting for at least one non-serving cell; and
performing the aperiodic CSI reporting for the at least one non-serving cell based at least in part on the MAC CE signaling received to update the association between the one or more CSI reporting configurations and the codepoint value of the CSI trigger state field.

2. The method of claim 1,
wherein the MAC CE signaling configures one or more CSI reporting configurations to be associated with a codepoint value of a CSI trigger state field in a downlink control information (DCI).

3. The method of claim 2,
wherein the one or more CSI reporting configurations updated to be associated with the codepoint value of the CSI trigger state codepoint in the DCI are identified in the MAC CE signaling using CSI reporting configuration IDs provided for the CSI reporting configurations by RRC signaling.

4. The method of claim 2, wherein the method further comprises:
receiving an indication of a set of CSI reporting configuration IDs via RRC signaling, wherein the set of CSI reporting configuration IDs include CSI reporting configuration IDs associated with the serving cell and CSI reporting configuration IDs associated with non-serving-cells;
determining which CSI reporting configuration IDs are associated with non-serving-cells; and
determining non-serving-cell group index based identifiers for the CSI reporting configuration IDs that are associated with non-serving cells,
wherein the one or more CSI reporting configurations configured to be associated with the codepoint value of a CSI trigger state field in the DCI are identified in the MAC CE signaling using the non-serving-cell group index based identifiers.

5. The method of claim 1,
wherein the MAC CE signaling configures one or more CSI resource configurations to be associated with a CSI reporting configuration.

6. The method of claim 5,
wherein the one or more CSI resource configurations are identified in the MAC CE signaling using CSI resource configuration IDs provided by RRC signaling,
wherein the CSI reporting configuration is identified in the MAC CE signaling using a CSI reporting configuration ID provided by RRC signaling.

7. The method of claim 5, wherein the method further comprises:
receiving an indication of a set of CSI reporting configuration IDs via RRC signaling, wherein the set of CSI reporting configuration IDs include CSI reporting configuration IDs associated with the serving cell and CSI reporting configuration IDs associated with non-serving-cells;
determining which CSI reporting configuration IDs are associated with non-serving-cells; and
determining non-serving-cell group index based identifiers for the CSI reporting configuration IDs that are associated with non-serving cells,
wherein the CSI reporting configuration is identified in the MAC CE signaling using a non-serving-cell group index based identifier.

8. The method of claim 5, wherein the method further comprises:
receiving an indication of a set of CSI resource configuration IDs via RRC signaling, wherein the set of CSI resource configuration IDs include CSI resource configuration IDs associated with the serving cell and CSI resource configuration IDs associated with non-serving-cells;
determining which CSI resource configuration IDs are associated with non-serving-cells; and
determining non-serving-cell group index based identifiers for the CSI resource configuration IDs that are associated with non-serving cells,
wherein the one or more CSI resource configurations configured to be associated with the CSI reporting configuration are identified in the MAC CE signaling using the non-serving-cell group index based identifiers.

9. The method of claim 1,
wherein the MAC CE signaling configures one or more reference signal (RS) resources to be associated with a CSI resource set.

10. The method of claim 9,
wherein the MAC CE signaling indicates a reference signal type for the RS resources to be associated with the CSI resource set, wherein the reference signal type is selected from CSI-RS or synchronization signal block (SSB) signal,
wherein the MAC CE signaling indicates a CSI-RS resource set ID or CSI-SSB resource set ID of the CSI resource set,
wherein the MAC CE signaling indicates one or more NZP-CSI-RS resource IDs or SSB indices.

11. The method of claim 1,
wherein the MAC CE signaling indicates a non-serving cell identifier and bandwidth part identifier associated with the one or more CSI reporting configurations.

12. A baseband processor configured to cause a wireless device to:
establish a wireless link with a cellular base station, wherein the cellular base station configures a serving cell and one or more non-serving cells for the wireless device via radio resource control (RRC) signaling;
receive channel state information (CSI) reporting configuration information from the cellular base station via RRC signaling;
receive media access control (MAC) control element (CE) signaling to update an association between one or more CSI reporting configurations and a codepoint value of a CSI trigger state field;
receive a CSI trigger state field indication triggering aperiodic CSI reporting from the cellular base station; and
perform CSI measurement and reporting to the cellular base station based at least in part on the MAC CE signaling received to update the association between the one or more CSI reporting configurations and the codepoint value of the CSI trigger state field.

13. The baseband processor of claim 12,
wherein the MAC CE signaling configures one or more CSI reporting configurations associated with non-serving cells to be associated with a codepoint value of a CSI trigger state field in a downlink control information (DCI),
wherein receiving the indication triggering the aperiodic CSI reporting includes receiving indication of the CSI trigger state codepoint via DCI signaling.

14. The baseband processor of claim 12,
wherein the MAC CE signaling configures one or more CSI resource configurations associated with non-serving cells to be associated with a CSI reporting configuration,
wherein the indication triggering the aperiodic CSI reporting indicates to use the CSI reporting configuration to perform the CSI reporting.

15. The baseband processor of claim 12,
wherein the MAC CE signaling configures one or more reference signal (RS) resources associated with non-serving cells to be associated with a CSI resource set,
wherein the indication triggering the aperiodic CSI reporting indicates to use a CSI reporting configuration that includes use of the CSI resource set to perform the CSI reporting.

16. A cellular base station, comprising:
an antenna;
a radio operably coupled to the antenna; and
a processor operably coupled to the radio;
wherein the cellular base station is configured to:
establish a wireless link with a wireless device, wherein the cellular base station configures a serving cell and one or more non-serving cells for the wireless device via radio resource control (RRC) signaling;
provide channel state information (CSI) reporting configuration information for the serving cell and the one or more non-serving cells to the wireless device via RRC signaling;
provide media access control (MAC) control element (CE) signaling to update an association between one or more CSI reporting configurations and a codepoint value of a CSI trigger state field;
provide a CSI trigger state field indication triggering aperiodic CSI reporting to the wireless device, wherein the CSI reporting triggered includes CSI reporting for at least a first non-serving cell; and
receive CSI reporting for the first non-serving cell from the wireless device, wherein the CSI reporting for the first non-serving cell is performed based at least in part on the MAC CE signaling provided to update the association between the one or more CSI reporting configurations and the codepoint value of the CSI trigger state field.

17. The cellular base station of claim 16,
wherein the MAC CE signaling configures one or more CSI reporting configurations associated with non-serving cells to be associated with a CSI trigger state codepoint in the downlink control information (DCI),
wherein providing the indication triggering the aperiodic CSI reporting includes providing an indication of the CSI trigger state codepoint via DCI signaling.

18. The cellular base station of claim 16,
wherein the MAC CE signaling configures one or more CSI resource configurations associated with non-serving cells to be associated with a CSI reporting configuration,
wherein the indication triggering the aperiodic CSI reporting indicates to use the CSI reporting configuration to perform the CSI reporting.

19. The cellular base station of claim 16,
wherein the MAC CE signaling configures one or more reference signal (RS) resources associated with non-serving cells to be associated with a CSI resource set,
wherein the indication triggering the aperiodic CSI reporting indicates to use a CSI reporting configuration that includes use of the CSI resource set to perform the CSI reporting.

20. The cellular base station of claim 16,
wherein the MAC CE signaling indicates a non-serving cell identifier and bandwidth part identifier associated with the one or more CSI reporting configurations.
